(19) United States
(12) Patent Application Publication
(10) Pub. No.: US 2021/0271142 A1
(43) Pub. Date: Sep. 2, 2021

(54) ARRAY SUBSTRATE AND METHOD FOR DRIVING THE SAME, AND DISPLAY DEVICE

(71) Applicants: CHONGQING BOE OPTOELECTRONICS TECHNOLOGY CO., LTD., Chongqing (CN); BOE TECHNOLOGY GROUP CO., LTD., Beijing (CN)

(72) Inventors: Shuai Chen, Beijing (CN); Xiuzhu Tang, Beijing (CN)

(21) Appl. No.: 17/256,435

(22) PCT Filed: May 18, 2020
(86) PCT No.: PCT/CN2020/090886

§ 371 Date: Dec. 28, 2020

(30) Foreign Application Priority Data
May 22, 2019 (CN) 201910429469.X

(51) Int. Cl. G02F 1/1362; G09G 3/36

(52) U.S. Cl. CPC G02F 1/136286; G09G 3/3688; G09G 3/3614

(57) ABSTRACT

An array substrate, a method for driving the array substrate, and a display device are provided. The array substrate includes: a plurality of data lines, a plurality of gate lines, and a plurality of pixel units arranged in an array, wherein each of the pixel units comprises one of one sub-pixel and a plurality of sub-pixels which are in the same row; sub-pixels comprised in pixel units which are in the same column are connected to the same one of the data lines; and two adjacent pixel units of pixel units which are in the same row are connected to different gate lines, and different sub-pixels in each of the pixel units are connected to different gate lines.

### CROSS-REFERENCE TO RELATED APPLICATION

The present disclosure is a 371 of PCT Patent Application Serial No. PCT/CN2020/090886, filed on May 18, 2020, which claims priority to Chinese Patent Application No. 201910429469.X, filed on May 22, 2019 and entitled “ARRAY SUBSTRATE AND DRIVING METHOD THEREOF, AND DISPLAY DEVICE”, the entire contents of which are incorporated herein by reference.

### TECHNICAL FIELD

The present disclosure relates to the field of displays, and in particular relates to an array substrate, a method for driving the same and a display device.

### BACKGROUND

Liquid crystal display (LCD) devices have been widely applied to the field of displays due to their advantages such as high resolution, light weight, and low energy consumption.

Each sub-pixel in a liquid crystal display device may include a thin-film transistor, a pixel electrode, a common electrode, and liquid crystal molecules. The thin-film transistors may be connected to data lines and the pixel electrodes, and the data lines may load data signals to the pixel electrodes through the thin film transistors, such that the liquid crystal molecules are deflected under the action of a potential difference between the pixel electrodes and the common electrode. However, if data signals of the same polarity are loaded to the pixel electrodes for a long time, the liquid crystal molecules may be polarized. That is, the deflection speed of the liquid crystal molecules becomes low, and the deflection amplitude becomes small.

### SUMMARY

The present disclosure provides an array substrate, a method for driving the same and a display device.

In an aspect, an array substrate is provided. The array substrate includes: a plurality of data lines, a plurality of gate lines, and a plurality of pixel units arranged in an array, wherein each of the pixel units includes one or more sub-pixels in the same row;

sub-pixels included in pixel units which are in the same column are connected to the same one of the data lines; and

two adjacent pixel units of pixel units which are in the same row are connected to different gate lines, and different sub-pixels in each of the pixel units are connected to different gate lines.

Optionally, the pixel units which are in the same row are connected to two gate line sets, and in the pixel units which are in the same row, pixel units in odd columns are connected to one of the two gate line sets, and pixel units in even columns are connected to the other of the two gate line sets; and

the number of the gate lines included in each of the gate line sets is the same as the number of the sub-pixels included in each of the pixel units.

Optionally, pixel units in even columns in one of two adjacent rows of pixel units and pixel units in odd columns in the other of the two adjacent rows of pixel units are connected to the same gate line set, respectively.

Optionally, an n^{th} sub-pixel in each of the pixel units in the odd columns is connected to an n^{th} gate line in one of the gate line sets, and an n^{th} sub-pixel in each of the pixel units in the even columns is connected to an n^{th} gate line in another gate line set,

wherein n is a positive integer not greater than N, and N is the number of the sub-pixels included in each of the pixel units.

Optionally, each of the pixel units includes a plurality of sub-pixels of different colors.

Optionally, the sub-pixels included in the pixel units which are in the same row are arranged cyclically in an order of a first-color sub-pixel, a second-color sub-pixel and a third-color sub-pixel.

Optionally, the first-color sub-pixels are red sub-pixels, the second-color sub-pixels are green sub-pixels, and the third-color sub-pixels are blue sub-pixels.

Optionally, each of the pixel units includes two sub-pixels of different colors.

Optionally, each of the data lines is between two columns of sub-pixels in one column of pixel units which are connected to the data line.

In another aspect, a method for driving an array substrate is provided and is applicable to the array substrate as described in the aspect above. The method includes:

providing gate drive signals sequentially to the gate lines included in the array substrate; and

providing polarity-reversing data signals to each of the data lines included in the array substrate, wherein data signals provided to two adjacent data lines are identical in polarity at the same time.

Optionally, a plurality of pixel units which are in the same row are connected to two gate line sets; and providing a polarity-reversing data signal to each of the data lines included in the array substrate includes:

providing each of the data lines with a data signal of a first polarity when the gate drive signals are provided to one of the two gate line sets; and

providing each of the data lines with a data signal of a second polarity when the gate drive signals are provided to the other of the two gate line sets.

In a further aspect, a display device is provided. The display device includes: the array substrate as described in the aspect above, and a driving circuit connected to the array substrate.

Optionally, the driving circuit includes: a source driving circuit and a gate driving circuit, wherein

the gate driving circuit is connected to a plurality of gate lines in the array substrate, and the source driving circuit is connected to a plurality of data lines in the array substrate;

the gate driving circuit is used to provide gate drive signals to the plurality of gate lines; and

the source driving circuit is used to provide data signals to the plurality of data lines.

### BRIEF DESCRIPTION OF THE DRAWINGS

FIG. 1 illustrates a schematic structural diagram of an array substrate according to an embodiment of the present disclosure;

FIG. 2 illustrates a timing diagram of signals of signal terminals in an array substrate according to an embodiment of the present disclosure;

FIG. 3 illustrates a schematic structural diagram of another array substrate according to an embodiment of the present disclosure;

FIG. 4 illustrates a flowchart of a method for driving an array substrate according to an embodiment of the present disclosure;

FIG. 5 illustrates an equivalent circuit diagram of a sub-pixel according to an embodiment of the present disclosure;

FIG. 6 illustrates a timing diagram of signals of signal terminals in another array substrate according to an embodiment of the present disclosure;

FIG. 7 illustrates a timing diagram of signals of signal terminals in a further array substrate according to an embodiment of the present disclosure; and

FIG. 8 and FIG. 9 illustrate schematic structural diagrams of a display device according to an embodiment of the present disclosure.

### DETAILED DESCRIPTION

In related arts, data signals loaded to pixel electrodes may be controlled to constantly reverse between a positive polarity and a negative polarity (referred to as polarity inversion), in order to avoid polarizing the liquid crystal molecules. However, due to coupling capacitance present between the common electrode and the data lines, the common electrode changes correspondingly under the action of the coupling capacitance as the polarity of the data signals loaded to the pixel electrodes changes, resulting in a large potential difference between the common electrode and the pixel electrodes. As a result, a charging efficiency of the data lines for charging the pixel electrodes is low.

Methods for polarity inversion may include frame inversion, column inversion, row inversion, dot inversion, etc. The dot inversion may include 2-dot inversion and (1+2)-dot inversion. The 2-dot inversion refers to that data signals loaded to respective sub-pixels included in each pixel unit are identical in polarity, and data signals loaded to two adjacent pixel units are opposite in polarity. The (1+2)-dot inversion refers to that data signals loaded to two adjacent sub-pixels in two adjacent pixel units are identical in polarity, and data signals located to respective sub-pixels included in each pixel unit are opposite in polarity, with each pixel unit including 2 sub-pixels.

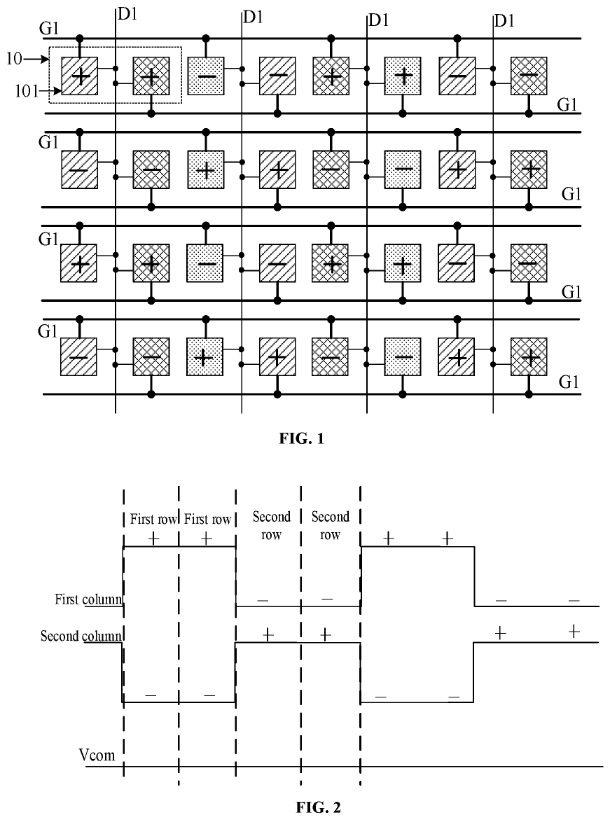

For ease of understanding, an embodiment of the 2-dot inversion is provided here as a reference for the description below. FIG. 1 illustrates a schematic structural diagram of a array substrate according to an embodiment of the present disclosure. FIG. 1 exemplifies an array substrate including eight gate lines G1, four data lines D1, and sixteen pixel units 10, with each pixel unit 10 including two sub-pixels 101. Referring to FIG. 1, data signals provided by each of the data lines D1 to the two sub-pixels 101 included in each of the pixel units 10 are identical in polarity; data signals provided by two adjacent data lines D1 to two pixel units 10 in the same row are opposite in polarity; and data signals provided by each of the data lines D1 to two adjacent pixel units 10 in the same column are opposite in polarity. As such, the 2-dot inversion is satisfied.

However, since the sub-pixels 101 in the two adjacent pixel units 10 in the same column are connected to the same gate line G1 in the array substrate illustrated in FIG. 1, the sub-pixels 101 connected to the same gate line G1, in the two pixel units 10, are turned on at the same time. That the sub-pixels are turned on as described in the embodiment of the present disclosure refers to that thin-film transistors included in the sub-pixels are turned on (to operate in a columnar area or a saturation area). Accordingly, two adjacent data lines D1 may provide data signals to the two adjacent pixel units 10 at the same time.

In addition, since the data signals provided by the two adjacent data lines D1 to the two pixel units 10 in the same row are opposite in polarity, the data signals provided by the two adjacent data lines D1 in the same time period are exactly opposite in a polarity reversal direction. Since coupling capacitance is also present between the data lines D1 and common electrode, a potential Vcom of the common electrode under a coupling effect of the coupling capacitance may be pulled down when the data signals are reversed from a positive polarity to a negative polarity, and may be pulled up when the data signals are reversed from the negative polarity to the positive polarity. Therefore, when the data signals provided by two adjacent data lines D1 in the same time period are exactly opposite in a polarity reversal direction, the directions for pulling the Vcom are also exactly opposite, and the Vcom is generally unchanged.

For example, pixel units 10 in a first column and a second column as illustrated in FIG. 1 are taken as an example. Referring to FIG. 2, when a first data line D1 sequentially writes data signals of positive polarity to a pixel unit 10 in a first row of the first column, a second data line D1 also simultaneously writes data signals of negative polarity to a pixel unit 10 in a first row of the second column. When the first data line D1 sequentially writes data signals of negative polarity to a pixel unit 10 in a second row of the first column, the second data line D1 also simultaneously writes data signals of positive polarity to a pixel unit 10 in a second row of the second column. Also referring to FIG. 2, Vcom remains constant under a pulling action of the polarity reversal.

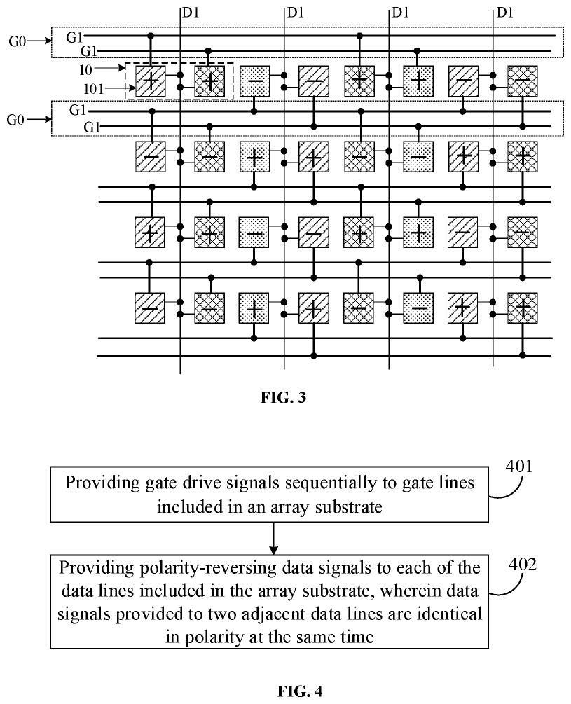

FIG. 3 illustrates a schematic structural diagram of an array substrate according to an embodiment of the present disclosure. As illustrated in FIG. 3, the array substrate may include: a plurality of data lines D1 (FIG. 3 merely illustrates 4 data lines D1), a plurality of gate lines G1 (FIG. 3 merely illustrates 10 data lines D1), and a plurality of pixel units 10 (merely sixteen pixel units 10 are illustrated in FIG. 3) arranged in an array.

Each of the pixel units 10 may include one or more sub-pixels 101 in the same row (each of the pixel units 10 illustrated in FIG. 3 includes two sub-pixels 101). Sub-pixels 101 included in the pixel units 10 in the same column may be connected to the same one of the data lines D1. Moreover, two adjacent pixel units 10 of the pixel units 10 in the same row may be connected to different gate lines, and different sub-pixels 101 in each of the pixel units 10 are connected to different gate lines.

When the plurality of gate lines G1 sequentially provide gate drive signals, sub-pixels 101 included in two adjacent pixel units 10 in the same row with respect to the array substrate illustrated in FIG. 1 may be ensured to be turned on at different times by connecting two adjacent pixel units 10 in the same row to different gate lines G1 and connecting different sub-pixels 101 included in each of the pixel units 10 to different gate lines, such that two adjacent data lines D1 may in turn provide data signals to the two adjacent pixel units 10 in the same row at different times, and in turn, the data signals loaded to any two adjacent pixel units 10 may be opposite. As a result, a requirement of polarity inversion is satisfied. When driving in the way of 2-dot inversion, data signals provided by two adjacent data lines D1 in the same time period are exactly the same in a polarity reversal direction, and accordingly, a direction for pulling Vcom is also the same. That is, Vcom may be pulled up or pulled down at the same time, thereby reducing the potential difference between common electrode and the pixel electrodes and improving the charging efficiency.

In summary, embodiments of the present disclosure provide an array substrate. When the array substrate is driven, each data line may provide a column of pixel units with data signals of constantly reversing polarity, and two adjacent data lines may provide the data signals of the same polarity at the same time. Since two adjacent pixel units which are in the same row are connected to different gate lines, the two adjacent pixel units which are in the same row may be turned on at different times, and two adjacent data lines may in turn provide data signals to the two adjacent pixel units which are in the same row at different times, to ensure that the polarities of the data signals provided to the two adjacent pixel units which are in the same row are opposite, thereby meeting the requirement that data signals loaded to two adjacent pixel units should be opposite in polarity. As a result, the polarization of the liquid crystal molecules is avoided. Moreover, since the data signals provided by adjacent data lines in the same time period are identical in a polarity reversal direction, potential of common electrode can be simultaneously pulled up or down, thereby reducing a potential difference between the common electrode and pixel electrodes, and improving a charging efficiency.

Optionally, referring to FIG. 3, a plurality of pixel units 10 in the same row may be connected to two gate line sets G0. Moreover, in the pixel units 10 in the same row, the pixel units 10 in odd columns may be connected to one of the two gate line sets G0, and the pixel units 10 in even columns may be connected to the other of the two gate line sets G0.

For example, pixel units 10 in first and third columns in the first row of pixel units 10 as illustrated in FIG. 3 are connected to a first gate line set G0; and pixel units 10 in second and fourth columns in the first row of pixel units 10 as illustrated in FIG. 3 are connected to a second gate line set G0.

In an embodiment of the present disclosure, the number of the gate lines G1 included in each of the gate line sets G0 may be the same as the number of the sub-pixels 101 included in each of the pixel units 10. For example, referring to FIG. 3, each of the pixel units 10 includes two sub-pixels 101, and accordingly, each of the gate line sets G0 illustrated in FIG. 3 includes two gate lines G1.

By connecting merely two gate line sets G0 to the same row of pixel units 10, the gate lines may be arranged merely with a small routing space. That is, a routing process can be simplified on the premise of improving a charging efficiency, which is beneficial to implementing a narrow bezel, and may reduce the production cost of the array substrate.

Optionally, the pixel units 10 in even columns in one of two adjacent rows of pixel units 10 and the pixel units 10 in odd columns in the other of the two adjacent rows of pixel units 10 may be connected to the same gate line set G0, respectively.

For example, referring to FIG. 3, pixel units 10 in the second and fourth columns in the first row of pixel units 10 and pixel units 10 in the first and third columns in the second row of pixel units 10 are connected to the same second gate line set G0, respectively. That is, the second gate line set G0 is shared.

On the premise of connecting the same row of pixel units 10 to two gate line sets G0, the routing space in the array substrate can be further saved by additionally sharing one gate line set G0 between pixel units 10 in odd and even columns of two adjacent rows of pixel nits 10, thereby simplifying the routing process and reducing the production cost.

Optionally, an n^{th} sub-pixel 101 in each of the pixel units 10 in odd columns may be connected to an n^{th} gate line G1 in one of the two gate line sets G0. An n^{th} sub-pixel 101 in each of the pixel units 10 in even columns may be connected to an n^{th} gate line G1 in another gate line set G0. Wherein n is a positive integer not greater than N, and N is the number of the sub-pixels 101 included in each of the pixel units 10. The arrangement of the gate lines G1 is facilitated by connecting the n^{th} sub-pixel 101 in each of the pixel units 10 to the n^{th} gate line in each of the gate line sets.

For example, referring to FIG. 3, each of the pixel units 10 includes two sub-pixels 101. That is, N is 2. Taking the first row of pixel units 10 as an example, a first sub-pixel 101 in a first column of pixel units 10 and a first sub-pixel 101 in a third column of pixel units 10 are both connected to a first gate line G1 in the first gate line set G0. A second sub-pixel 101 in the second column of pixel units 10 and a second sub-pixel 101 in the third column of pixel units 10 are both connected to a second gate line G1 in the first gate line set G0.

In embodiments of the present disclosure, each of the pixel units 10 may include a plurality of sub-pixels 101 of different colors. Moreover, sub-pixels 101 included in two adjacent pixel units 10 may be different in color.

For example, for the array substrate illustrated in FIG. 3, the colors of two sub-pixels 101 included in a first pixel unit 10 in a first row may include red and green; and the colors of two sub-pixels 101 included in a second pixel unit 10 in the first row may include green and blue.

Optionally, the sub-pixels 101 included in the plurality of pixel units 10 in the same row may be arranged cyclically in an order of a first-color sub-pixel, a second-color sub-pixel and a third-color sub-pixel. The first-color sub-pixels may be red sub-pixels, the second-color sub-pixels may be green sub-pixels, and the third-color sub-pixels may be blue sub-pixels.

Optionally, each of the pixel units 10 may include two sub-pixels 101 of different colors. When sub-pixels 101 included in a plurality of pixel units 10 in the same row are arranged cyclically in an order of the red sub-pixel, the green sub-pixel, and the blue sub-pixel, each of the pixel units 10 in a first column with respect to the array substrate illustrated in FIG. 3 may accordingly include two sub-pixels 101, i.e. a red sub-pixel and a green sub-pixel. Each of the pixel units 10 in a second column may include two sub-pixels 101, i.e. a blue sub-pixel and a red sub-pixel. Each of the pixel units 10 in a third column may include two sub-pixels 101, i.e. a green sub-pixel and a blue sub-pixel. Each of the pixel units 10 in a fourth column may include two sub-pixels 101, i.e. a red sub-pixel and a green sub-pixel.

Optionally, referring to FIG. 3, when each of the pixel units 10 includes two sub-pixels 101, each column of pixel unit 10 may include two columns of sub-pixels 101. Accordingly, referring to FIG. 3, each of the data lines D1 may be between two columns of sub-pixels 101 in a column of pixel units 10 connected to said data line. The arrangement of each of the data lines D1 between two columns of sub-pixels 101 contributes to a connection between each column of sub-pixels 101 included in each column of pixel units 10 and the data line D1.

In summary, embodiments of the present disclosure provide an array substrate. When the array substrate is driven, each data line may provide a column of pixel units with data signals of constantly reversing polarity, and two adjacent data lines may provide the data signals of the same polarity at the same time. Since two adjacent pixel units which are in the same row are connected to different gate lines, the two adjacent pixel units which are in the same row may be turned on at different times, and two adjacent data lines may in turn provide data signals to the two adjacent pixel units which are in the same row at different times, to ensure that the polarities of the data signals provided to the two adjacent pixel units which are in the same row are opposite, thereby meeting the requirement that data signals loaded to two adjacent pixel units should be opposite in polarity. As a result, the polarization of the liquid crystal molecules is avoided. Moreover, since the data signals provided by adjacent data lines in the same time period are identical in a polarity reversal direction, potential of common electrode can be simultaneously pulled up or down, thereby reducing a potential difference between the common electrode and pixel electrodes, and improving a charging efficiency.

FIG. 4 illustrates a flowchart of a method for driving an array substrate according to an embodiment of the present disclosure. The method may be applicable to the array substrate as illustrated in FIG. 3. As illustrated in FIG. 4, the method may include the following steps.

In step 401, gate drive signals are provided sequentially to gate lines included in an array substrate.

In an embodiment of the present disclosure, the gate lines included in the array substrate may be connected to the gate driving circuit. The gate driving circuit may sequentially provide gate drive signals to gate lines from the first row to the last row.

In step 402, polarity-reversing data signals are provided to each of the data lines included in the array substrate, wherein data signals provided to two adjacent data lines are identical in polarity at the same time.

In an embodiment of the present disclosure, the data lines included in the array substrate may all be connected to the source driving circuit. The source driving circuit may provide data signals of constantly reversing polarity to each of the data lines, and the source driving circuit may provide data signals of the same polarity to two adjacent data lines at the same time.

In summary, embodiments of the present disclosure provide a method for driving an array substrate. According to the method, data signals of constantly reversing polarity may be provided to each data line included in the array substrate, and the data signals of the same polarity may be provided to two adjacent data lines at the same time. Therefore, the sub-pixels included in two adjacent pixel units which are in the same row in the array substrate are connected to different gate lines. That is, when two adjacent data lines provide data signals to two adjacent pixel units which are in the same row at different times, the data signals provided to the two adjacent pixel units which are in the same row can be ensured to be opposite in polarity, and the requirement that the data signals loaded to any two adjacent pixel units should be opposite in polarity is met. Moreover, since the data signals provided by adjacent data lines in the same time period are identical in a polarity reversal direction, potential of common electrode can be simultaneously pulled up or down, thereby reducing a potential difference between the common electrode and pixel electrodes, and improving a charging efficiency.

Optionally, referring to FIG. 3, a plurality of pixel units 10 in the same row in an embodiment of the present disclosure may be connected to two gate line sets G0. Accordingly, step 402 may include the following steps.

When gate drive signals are provided to one of the two gate line sets G0, a data signal of a first polarity is provided to each of the data lines; and when gate drive signals are provided to the other of the two gate line sets G0, a data signal of a second polarity is provided to each of the data lines. The first polarity may be a positive polarity, and the second polarity may be a negative polarity.

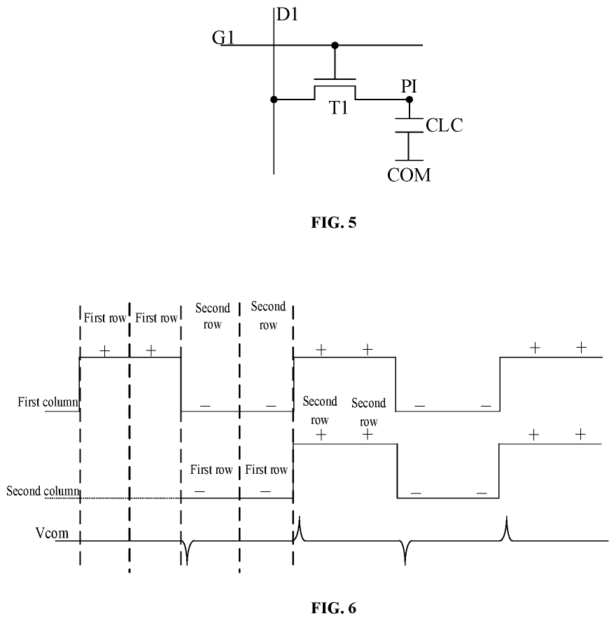

Optionally, FIG. 5 illustrates an equivalent circuit diagram of a sub-pixel according to an embodiment of the present disclosure. As illustrated in FIG. 5, each of the sub-pixels may include: a thin-film transistor T1 and a liquid crystal capacitor CLC. Each of the liquid crystal capacitors CLC may be a capacitor formed by a pixel electrode PI and a common electrode COM. Each of the thin-film transistors T1 may have a gate connected to a gate line G1, a first electrode connected to a data line D1, and a second electrode connected to one terminal of each of the liquid crystal capacitors CLC. When the gate lines G1 provide gate drive signals to the thin-film transistors T1, the data lines D1 may transmit data signals to the pixel electrodes PI through the thin-film transistors T1, enabling the charging of the pixel electrodes PI.

FIG. 6 illustrates a timing diagram of signals according to an embodiment of the present disclosure. Taking the first column of pixel units and the second column of pixel units in the array substrate illustrated in FIG. 3 as an example, and taking a circuit structure of sub-pixels 101 as a structure illustrated in FIG. 5 as an example, a principle for driving the array substrate according to the embodiments of the present disclosure is introduced.

Referring to FIG. 3, since two adjacent pixel units 10 in the same row are connected to different gate lines G1, sub-pixels 101 included in each of the pixel units 10 are also connected to different gate lines G1. Therefore, when two gate lines G1 included in a first gate line set G0 connected to the first row of pixel units 10 sequentially provide gate drive signals, thin-film transistors T1 in two sub-pixels 101 included in the pixel units 10 in the first row of a first column are turned on sequentially. Referring to FIG. 6, a first data line D1 may sequentially provide data signals of positive polarity to two sub-pixels 101 included in the pixel unit 10 in the pixel unit 10 in the first row of the first column.

When the gate drive signals are continued to be sequentially provided to the two gate lines G1 included in the second gate line set G0 connected to the first row of pixel units 10, thin-film transistors T1 in two sub-pixels 101 included in a pixel unit 10 in the second row of the first column are turned on sequentially. At the same time, thin-film transistors T1 in two sub-pixels 101 included in a pixel unit 10 in a first row of a second column are also turned on sequentially. Referring to FIG. 6, while the two sub-pixels 101 included in the pixel unit 10 in the second row of the first column are sequentially provided with data signals of negative polarity by a first data line D1, the two sub-pixels 101 included in the pixel unit 10 in the first row of the second column may be provided with data signals of negative polarity by a second data line D1. A drive timing after the second row may be in a similar way.

Based on the above analysis and referring to FIG. 6, it can be seen that when the array substrate illustrated in FIG. 3 is driven in a way of 2-dot inversion, data signals provided to two adjacent data lines D1 at the same time may be allowed to be identical in polarity, and data signals provided by the two adjacent data lines D1 in the same time period may be in turn allowed to be identical in a polarity reversal direction. Therefore, Vcom may be pulled up or down at the same time.

Since Vcom may be pulled down when the polarity of the data signal is reversed from a positive polarity to a negative polarity, Vcom may accordingly be pulled up when the polarity of the data signals is reversed from the negative polarity to the positive polarity. Therefore, referring to FIG. 6, a downward fluctuation (i.e. a ripple) of Vcom may be caused when the polarities of the data signals provided by the first data line D1 and the second data line D1 in the same time period are reversed from the positive polarity to the negative polarity at the same time. An upward ripple of Vcom may be caused when the polarities of the data signals provided by the first data line D1 and the second data line D1 in the same time period are reversed from the negative polarity to the positive polarity at the same time. In addition, a potential V finally written to the liquid crystal molecules satisfies: V=Vp−Vcom. Therefore, regardless of pulling down or up Vcom, a potential difference between the pixel electrodes and the common electrode may be reduced to improve the charging efficiency.

In addition, the common electrode is capable of stabilizing a voltage. Therefore, referring to FIG. 6, the upward and downward ripples occurring to Vcom gradually return to a potential before the ripples are generated, such that the pixel electrodes may be charged normally. Moreover, a coupling capacitor is also present between each of the pixel electrodes and the common electrode. Therefore, when a potential Vcom of the common electrode is pulled down, a potential of each of the pixel electrodes may be simultaneously pulled down by means of a coupling effect of the coupling capacitor; and when the potential Vcom of the common electrode is pulled up, the potential of each of the pixel electrodes may be simultaneously pulled up by means of the coupling effect of the coupling capacitor, such that the potential of each of the pixel electrodes may accurately reach a target potential. That is, a potential that needs to be written to the liquid crystal molecules is reached, which reduces power consumption of the source driving circuit to a certain extent.

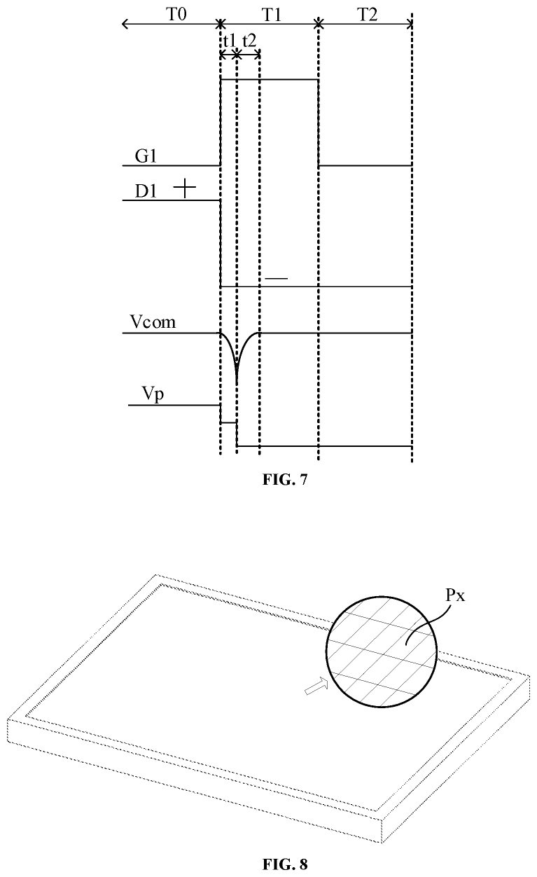

FIG. 7 illustrates a timing diagram of signals in another array substrate according to an embodiment of the present disclosure. Taking driving a first sub-pixel 101 in a pixel unit 10 in a second row of a first column in the array substrate illustrated in FIG. 3 as an example, and taking a circuit structure of said sub-pixel 101 as a structure illustrated in FIG. 5 as an example, a principle for driving said sub-pixel 101 is introduced. Referring to FIG. 3, it may be seen that the first sub-pixel 101 in the second row of the first column is connected to a first gate line G1 in a second gate line set G0, and is connected to a first data line D1.

Referring to FIG. 7, in stage T1, a first gate line G1 in a second gate line set G0 provides a gate drive signal, a thin-film transistor T1 in a first sub-pixel 101 in a second row of a first column is turned on, and a first data line D1 provides data signal of negative polarity to said sub-pixel 101. From FIG. 7, it may be seen that in stage T0 before stage T1, a polarity of the data signals provided by the first data line D1 is a positive polarity. Therefore, in a transition from stage T0 to stage T1, the data signals provided by the first data line D1 are reversed from the positive polarity to the negative polarity. Accordingly, referring to FIG. 7, at initial sub-stage t1 of said stage T1, a downward ripple of the potential Vcom of the common electrode may be caused. At the same time, a potential Vp of each of the pixel electrodes is also pulled down under the coupling effect of the coupling capacitor. At sub-stage t2 after said sub-stage t1, the potential Vcom of the common electrode under the action of the voltage stabilizing ability of the common electrode gradually return to a potential before the ripple is generated. At the same time, the potential Vp of each of the pixel electrodes is further pulled down to charge liquid crystal molecules in the first sub-pixel 101 in the second row of the first column. Therefore, this stage T1 may also be referred to as a charging stage.

In stage T2, the first gate line G1 in the second gate line set G0 stops providing gate drive signals, and the thin-film transistor T1 in the first sub-pixel 101 in the second row of the first column and second row is turned off. Liquid crystal molecules in the first sub-pixel 101 may be deflected to a target angle, and accordingly, the first sub-pixel 101 starts to emit light. Therefore, this stage T2 may also be referred to as a display stage.

In summary, embodiments of the present disclosure provide a method for driving an array substrate. According to the method, data signals of constantly reversing polarity may be provided to each data line included in the array substrate, and the data signals of the same polarity may be provided to two adjacent data lines at the same time. Therefore, the sub-pixels included in two adjacent pixel units which are in the same row in the array substrate are connected to different gate lines. That is, when two adjacent data lines provide data signals to two adjacent pixel units which are in the same row at different times, the data signals provided to the two adjacent pixel units which are in the same row can be ensured to be opposite in polarity, and the requirement that the data signals loaded to any two adjacent pixel units should be opposite in polarity is met. Moreover, since the data signals provided by adjacent data lines in the same time period are identical in a polarity reversal direction, potential of common electrode can be simultaneously pulled up or down, thereby reducing a potential difference between the common electrode and pixel electrodes, and improving a charging efficiency.

An embodiment of the present disclosure further provides a display device. The display device may include: an array substrate as illustrated in FIG. 3, and a driving circuit connected to the array substrate.

The driving circuit may include: a source driving circuit and a gate driving circuit. The gate driving circuit may be connected to a plurality of gate lines in the array substrate, and the source driving circuit may be connected to a plurality of data lines in the array substrate. The gate driving circuit is used to provide gate drive signals to the plurality of gate lines; and the source driving circuit is used to provide data signals to the plurality of data lines.

Optionally, the display device may include: a display panel, electronic paper, a mobile phone, a tablet computer, a television, a displayer, a notebook computer, a digital photo frame or any other products or components that have a display function.

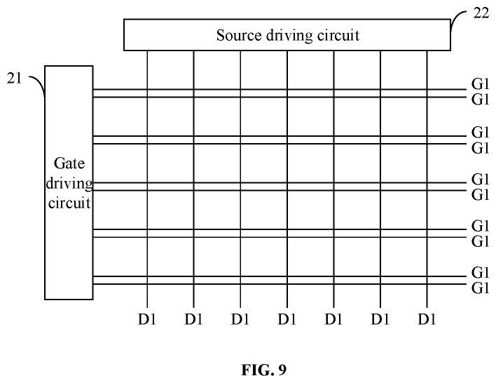

FIG. 8 and FIG. 9 illustrate schematic structural diagrams of a display device according to an embodiment of the present disclosure. As illustrated in FIG. 8, the display device may include several rows and several columns of sub-pixels Px in a display area. As illustrated in FIG. 9, the gate driving circuit 21 is connected to a plurality of gate lines G1 to provide gate drive signals to the plurality of gate lines; and the source driving circuit 22 is connected to a plurality of data lines D1 to provide data signals to the plurality of data lines. In comparison with FIG. 3, it may be known that the plurality of data lines D1 and the plurality of gate lines G1 are intersected to define the plurality of sub-pixels Px in the array substrate. In an exemplary embodiment, the plurality of sub-pixels Px are all in an active display area of the display device, and the gate driving circuit 21 and the source driving circuit 22 are both outside the active display area.

A person skilled in the art may clearly understand that for the convenience and brevity of the description, a reference may be made to the corresponding processes in the forgoing method embodiments for the detailed working processes of the array substrate and display device as described above, the details of which will not be repeated here.

The above are merely exemplary embodiments of the present disclosure, but are not intended to limit the present disclosure. Any modifications, equivalent replacements and improvements made within the spirits and principles of the present disclosure shall all fall in the protection scope of the present disclosure.

In an exemplary embodiment, a non-transitory computer-readable storage medium including at least one instruction (such as a memory including at least one instruction) is further provided. The at least one instruction may be executed by a processor of a computer to perform a method for driving the array substrate as illustrated in the embodiments of the present disclosure. For example, the non-transitory computer-readable storage medium may be a ROM, a random-access memory (RAM), a CD-ROM, a magnetic tape, a floppy disk, an optical data storage device and the like.

Described above are merely exemplary embodiments of the present disclosure, but not intended to limit the present disclosure. Any modifications, equivalent substitutions, improvements and the like made within the spirits and principles of the present disclosure shall fall within the protection scope as defined in the appended claims.

What is claimed is:

1. An array substrate, comprising: a plurality of data lines, a plurality of gate lines, and a plurality of pixel units arranged in an array, wherein each of the pixel units comprises one of one sub-pixel and a plurality of sub-pixels which are in the same row;
sub-pixels comprised in pixel units which are in the same column are connected to the same one of the data lines; and
two adjacent pixel units of pixel units which are in the same row are connected to different gate lines, and different sub-pixels in each of the pixel units are connected to different gate lines.

2. The array substrate according to claim 1, wherein
the pixel units which are in the same row are connected to two gate line sets, and in the pixel units which are in the same row, pixel units in odd columns are connected to one of the two gate line sets, and pixel units in even columns are connected to the other of the two gate line sets; and
the number of the gate lines comprised in each of the gate line sets is the same as the number of the sub-pixels comprised in each of the pixel units.

3. The array substrate according to claim 2, wherein
pixel units in even columns in one of two adjacent rows of pixel units and pixel units in odd columns in the other of the two adjacent rows of pixel units are connected to the same gate line set, respectively.

4. The array substrate according to claim 2, wherein
an nth sub-pixel in each of the pixel units in the odd columns is connected to an nth gate line in one of the gate line sets, and an nth sub-pixel in each of the pixel units in the even columns is connected to an nth gate line in another gate line set,
wherein n is a positive integer not greater than N, and N is the number of the sub-pixels comprised in each of the pixel units.

5. The array substrate according to claim 1, wherein each of the pixel units comprises a plurality of sub-pixels of different colors.

6. The array substrate according to claim 5, wherein the sub-pixels comprised in the pixel units which are in the same row are arranged cyclically in an order of a first-color sub-pixel, a second-color sub-pixel and a third-color sub-pixel.

7. The array substrate according to claim 6, wherein the first-color sub-pixels are red sub-pixels, the second-color sub-pixels are green sub-pixels, and the third-color sub-pixels are blue sub-pixels.

8. The array substrate according to claim 5, wherein each of the pixel units comprises two sub-pixels of different colors.

9. The array substrate according to claim 8, wherein each of the data lines is between two columns of sub-pixels in one column of pixel units which are connected to the data line.

10. A display device, comprising: an array substrate and a plurality of driving circuits connected to the array substrate; wherein the array substrate comprises a plurality of data lines, a plurality of gate lines, and a plurality of pixel units arranged in an array, and each of the pixel units comprises one of one sub-pixel and a plurality of sub-pixels which are in the same row;
sub-pixels comprised in pixel units which are in the same column are connected to the same one of the data lines; and
two adjacent pixel units of pixel units which are in the same row are connected to different gate lines, and different sub-pixels in each of the pixel units are connected to different gate lines.

11. The display device according to claim 10, wherein the driving circuits comprises: a source driving circuit and a gate driving circuit, wherein
the gate driving circuit is connected to at least two of the gate lines in the array substrate, and the source driving circuit is connected to at least two of the data lines in the array substrate;
the gate driving circuit is used to provide gate drive signals to the at least two of the gate lines; and
the source driving circuit is used to provide data signals to the at least two of the data lines.

12. The display device according to claim 10, wherein the gate driving circuit is further used to sequentially provide gate drive signals to the gate lines comprised in the array substrate; and
the source driving circuit is further used to provide a polarity-reversing data signal to each of the data lines comprised in the array substrate, wherein data signals provided to two adjacent data lines are identical in polarity at the same time.

13. The display device according to claim 12, wherein the pixel units which are in the same row are connected to two gate line sets; and the source driving circuit is further used to:
provide each of the data lines with a data signal of a first polarity when gate drive signals are provided to one of the two gate line sets; and
provide each of the data lines with a data signal of a second polarity gate drive signals are provided to the other of the two gate line sets.

14. A method for driving an array substrate, wherein the array substrate is the array substrate according to claim 1, and the method comprises:
providing gate drive signals sequentially to the gate lines comprised in the array substrate; and
providing polarity-reversing data signals to each of the data lines comprised in the array substrate, wherein data signals provided to two adjacent data lines are identical in polarity at the same time.

15. The method according to claim 14, wherein a plurality of pixel units which are in the same row are connected to two gate line sets; and providing a polarity-reversing data signal to each of the data lines comprised in the array substrate comprises:
providing each of the data lines with a data signal of a first polarity when the gate drive signals are provided to one of the two gate line sets; and
providing each of the data lines with a data signal of a second polarity when the gate drive signals are provided to the other of the two gate line sets.

16. The display device according to claim 10, wherein
the pixel units which are in the same row are connected to two gate line sets, and in the pixel units which are in the same row, pixel units in odd columns are connected to one of the two gate line sets, and pixel units in even columns are connected to the other of the two gate line sets; and
the number of the gate lines comprised in each of the gate line sets is the same as the number of the sub-pixels comprised in each of the pixel units.

17. The display device according to claim 16, wherein
pixel units in even columns in one of two adjacent rows of pixel units and pixel units in odd columns in the other of the two adjacent rows of pixel units are connected to the same gate line set, respectively.

18. The display device according to claim 16, wherein
an nth sub-pixel in each of the pixel units in the odd columns is connected to an nth gate line in one of the gate line sets, and an nth sub-pixel in each of the pixel units in the even columns is connected to an nth gate line in another gate line set,
wherein n is a positive integer not greater than N, and N is the number of the sub-pixels comprised in each of the pixel units.

19. The display device according to claim 10, wherein each of the pixel units comprises a plurality of sub-pixels of different colors;
the sub-pixels comprised in the pixel units which are in the same row are arranged cyclically in an order of a first-color sub-pixel, a second-color sub-pixel and a third-color sub-pixel; and
the first-color sub-pixels are red sub-pixels, the second-color sub-pixels are green sub-pixels, and the third-color sub-pixels are blue sub-pixels.

20. The display device according to claim 19, wherein each of the pixel units comprises two sub-pixels of different colors; and
each of the data lines is between two columns of sub-pixels in one column of pixel units which are connected to the data line.
